(19) United States
(12) Patent Application Publication
(10) Pub. No.: US 2003/0023988 A1
(43) Pub. Date: Jan. 30, 2003

(54) System and method for restoring digital TV signal

(76) Inventors: Youne-Sang Lee, Suwon-city (KR); Sang-Jin Hong, Suwon-city (KR)

Correspondence Address: Robert E. Bushnell, Suite 300, 1522 K Street, N.W., Washington, DC, 20005, US

(21) Appl. No.: 10/078,376

(22) Filed: Feb. 21, 2002

(30) Foreign Application Priority Data
Jul. 16, 2001 (KR) 42812/2001

(51) Int. Cl. H04N 7/16

(52) U.S. Cl. 725/143; 725/139; 725/149

(57) ABSTRACT

A system for restoring a digital TV signal, comprising a signal dividing means receiving the digital TV signal, and dividing the digital TV signal into digital video signals and digital audio signals after a predetermined signal processing; a video decoding means decoding the digital video signals outputted from the signal dividing means into analog video signals, and outputting low frequency analog video signals by colors; an audio decoding means decoding the digital audio signals outputted from the signal dividing means into analog audio signals with a plurality of channels corresponding to predetermined frequencies; a plurality of frequency-modulators frequency-modulating the low frequency analog video signals and the analog audio signals, in response to intermediate frequencies, respectively; a computer system having a wireless transmitter wirelessly transmitting the signals modulated by the frequency-modulators; a plurality of wireless receivers wirelessly receiving the analog video and audio signals transmitted from the wireless transmitter; a plurality of frequency demodulators for frequency-demodulating the analog video and audio signals into Y/Pb/Pr video and 5.1 channel audio.

### CLAIM OF PRIORITY

This application makes reference to, incorporates the same herein, and claims all benefits accruing under 35 U.S.C §119 from an application entitled System and Method for Restoring Digital Tv Signal earlier filed in the Korean Industrial Property Office on Jul. 16 2001, and there duly assigned Ser. No. 2001-42812 by that Office.

### BACKGROUND OF THE INVENTION

1. Field of the Invention

The present invention relates in general to a system and a method for restoring a digital TV signal, and more particularly, to a system and a method for restoring a digital TV signal in which the digital TV signal is wirelessly transmitted from a computer system and restored at a remote display apparatus.

2. Description of the Related Art

Currently, a digital broadcasting system transmits a TV signal, after digitizing audio and video signals thereof and compressing them, in an MPEG-2 (Motion Picture Experts Group-2) manner. Thus, a digital TV that can receive the digitized TV signal and display a picture in high quality is on the market.

Inside the digital TV is provided a signal processing part so as to receive and process the compressed digital TV signal. However, some digital TV sets, e.g., a wall mounted digital TV set, require a separate digital signal processing setup box is in order to process the digital TV signal.

On the other hand, in the case of a computer system equipped with a digital TV tuner card, if the computer system is connected to a display apparatus such as the digital TV or a projector, the digital broadcasting can be displayed on the display apparatus without a digital signal processing setup box.

Herein below, a computer system for displaying a digital TV signal, received at a digital TV tuner card, on a digital TV, instead of the computer system's monitor, will be described. As shown in FIG. 5, the computer system which can display the digital broadcasting is comprised of a digital TV tuner card 111 receiving a digital TV signal and dividing it into an audio signal and a video signal compressed in the MPEG-2 manner, a video decoder 114 outputting R/G/B signals by ant decoding the video signal compressed in the MPEG-2 manner, a video signal transforming unit (not shown), included in video decoder 114, transforming the R/G/B signals from the video decoder 114 into Y/Pb/Pr signals, a VGA (Video Graphics Adapter) card 117 processing the R/G/B signals from the video decoder 114 and outputting an analog video signal, and a monitor 119 displaying the analog video signal from the VGA card 117 thereon. The Y/Pb/Pr signals from the video transforming unit is transmitted to and displayed on a digital TV 122.

Further, the audio signal from the digital TV tuner card 111 is transformed into an SPDIF (Sony Philips Digital Interface Format) signal by a sound card 115, and divided into six audio data corresponding to 5.1 (five speakers and one woofer) channels by an audio apparatus (an amplifier) equipped with an audio decoder 123 so as to be outputted through speakers 124 through 129.

The computer system, however, is generally arranged in a one room, but the digital TV and the audio apparatus applicable to the 5.1 channels are arranged in an a separate room. Accordingly, a plurality of cables are needed for connecting the computer system to the digital TV and the audio apparatus, thus a signal loss may be generated according to a length of the cables, and the beauty of surroundings may be spoiled by the cables.

### SUMMARY OF THE INVENTION

Accordingly, the present invention has been made keeping in mind the above-described shortcomings and user's need, and an object of the present invention is to provide a system and a method for restoring a digital TV signal, in which the digital TV signal is wirelessly transmitted from a computer system and restored at a remote display apparatus.

This and other objects of the present invention may be accomplished by the provision of a system for reproducing a digital TV signal, comprising a computer system and a display system, in which the computer system comprises a signal dividing means receiving the digital TV signal, and dividing the digital TV signal into digital video signals and digital audio signals after a predetermined signal processing, a video decoding means decoding the digital video signals outputted from the signal dividing means into analog video signals, and outputting low frequency analog video signals by colors, an audio decoding means decoding the digital audio signals outputted from the signal dividing means into analog audio signals with a plurality of channels corresponding to predetermined frequencies, a plurality of frequency-modulators frequency-modulating the low frequency analog video signals and the analog audio signals, in response to intermediate frequencies, respectively, and a wireless transmitter wirelessly transmitting the signals modulated by the frequency-modulators; and the display system having a plurality of first wireless receivers wirelessly receiving the analog audio signals transmitted from the wireless transmitter, via the channels, a plurality of first frequency demodulators respectively connected to the first wireless receivers and frequency-demodulating the analog audio signals, a plurality of second wireless receivers wirelessly receiving the analog video signals transmitted from the wireless transmitter, a plurality of second frequency demodulators respectively connected to the second wireless receivers and frequency-demodulating the analog video signals by the colors, and display and audio apparatuses outputting the video and audio signals demodulated by the first and second frequency demodulators, respectively.

Effectively, the signal dividing means is comprised of a digital TV tuner card including a tuner receiving the digital TV signal, a VSB (Vestigial Side Band) demodulating part demodulating a high frequency signal output by the tuner into a VSB analog signal, a Viterbi decoder transforming the VSB analog signal into a digital signal, and a demultiplexer dividing the digital signal transformed by the Viterbi decoder into a separate video signal and audio signal.

Further, the video decoding means includes a video decoder decoding the video signal outputted from the demultiplexer into R/G/B signals, and a video signal transforming part transforming the R/G/B signals into Y/Pb/Pr low frequency analog video signals.

The audio decoding means includes an audio decoder decoding the audio signal outputted from the demultiplexer into six audio signals corresponding to the 5.1 channel audio format in an AC-3 (Dolby Digital) manner. Effectively, the audio apparatus is comprised of six speakers applicable to the 5.1 channels.

The wireless transmitter and the first and second wireless receivers are comprised of at least one antenna, respectively.

This and other objects of the present invention may be accomplished by the provision of a system for restoring a digital video signal, comprising a computer system and a display system, in which the computer system comprising a video signal outputting means outputting the digital video signal, a video decoding means decoding the digital video signals outputted from the video signal outputting means into analog video signals, and outputting low frequency analog video signals by colors, a plurality of frequency-modulators frequency-modulating the low frequency analog video signals into high frequency signals, in response to intermediate frequencies, respectively, and a wireless transmitter wirelessly transmitting the signals modulated by the frequency-modulators; and the display system comprising a plurality of wireless receivers wirelessly receiving the analog video signals transmitted from the wireless transmitter, a plurality of frequency demodulators respectively connected to the wireless receivers and frequency-demodulating the analog video signals by colors, and a display apparatus outputting the video signals demodulated by the frequency demodulators.

This and other objects of the present invention may be accomplished by the provision of a system for restoring a digital audio signal, comprising a computer system and an audio system, in which the computer system comprising an audio signal outputting means outputting the digital audio signal, an audio decoding means decoding the digital audio signals outputted from the audio signal outputting means into analog audio signals after dividing the digital audio signals corresponding to a plurality of channels having predetermined frequencies, a plurality of frequency-modulators frequency-modulating the low frequency analog audio signals into high frequency signals, in response to intermediate frequencies, respectively, and a wireless transmitter wirelessly transmitting the signals modulated by the frequency-modulators; and the audio system comprising a plurality of wireless receivers wirelessly receiving the analog audio signals transmitted from the wireless transmitter, a plurality of frequency demodulators respectively connected to the wireless receivers and frequency-demodulating the analog audio signals corresponding to the channels, and an audio apparatus outputting the audio signals demodulated by the frequency demodulators.

Preferably, the audio signal outputting means is comprised of a digital TV tuner card including a tuner receiving the digital TV signal, a VSB (Vestigial Side Band) demodulating part demodulating a high frequency signal received by the tuner into a VSB analog signal, a viterbi decoder transforming the VSB analog signal into a digital signal, and a demultiplexer dividing the digital signal transformed by the viterbi decoder into the video signal and the audio signal.

According to another aspect of the present invention, the above and other objects may be also achieved by the provision of a method for restoring a digital TV signal, comprising the steps of dividing the digital TV signal into a digital video signal and an digital audio signal after a predetermined signal processing; decoding the digital video signal into low frequency analog video signal, by colors; decoding the digital audio signal into analog audio signal with a plurality of channels corresponding to predetermined frequencies; modulating the low frequency analog video and audio signals into high frequency signals having predetermined intermediate frequencies, respectively; transmitting at least one of the frequency-modulated video and audio signals by wireless; receiving at least one of the transmitted video and audio signals and demodulating the received signals; and outputting at least one of the demodulated video and audio signals to display and audio apparatuses.

Herein, the step of decoding the digital audio signal comprises the step of transforming the digital audio signal into six signals corresponding to the 5.1 channel audio format.

Herein, the audio apparatus is comprised of six speakers applicable to 5.1 channels.

### BRIEF DESCRIPTION OF THE DRAWINGS

more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a system according to the present invention for restoring a digital TV signal according to the principles of the present invention;

FIG. 2a is a block diagram showing a frequency modulation by the audio modulators of FIG. 1;

FIG. 2b is a block diagram showing a frequency demodulation by the audio demodulators of FIG. 1;

FIG. 3a is a block diagram showing a frequency modulation by the video modulators of FIG.

FIG. 3b is a block diagram showing a frequency demodulation by the video demodulators of FIG. 1;

FIG. 4 is a flow chart of a method according to the present invention for restoring the digital TV signal according to the principles of the present invention; and

FIG. 5 is a conventional system for restoring a digital TV signal.

### DETAILED DESCRIPTION OF THE PREFERRED EMBODIMENT

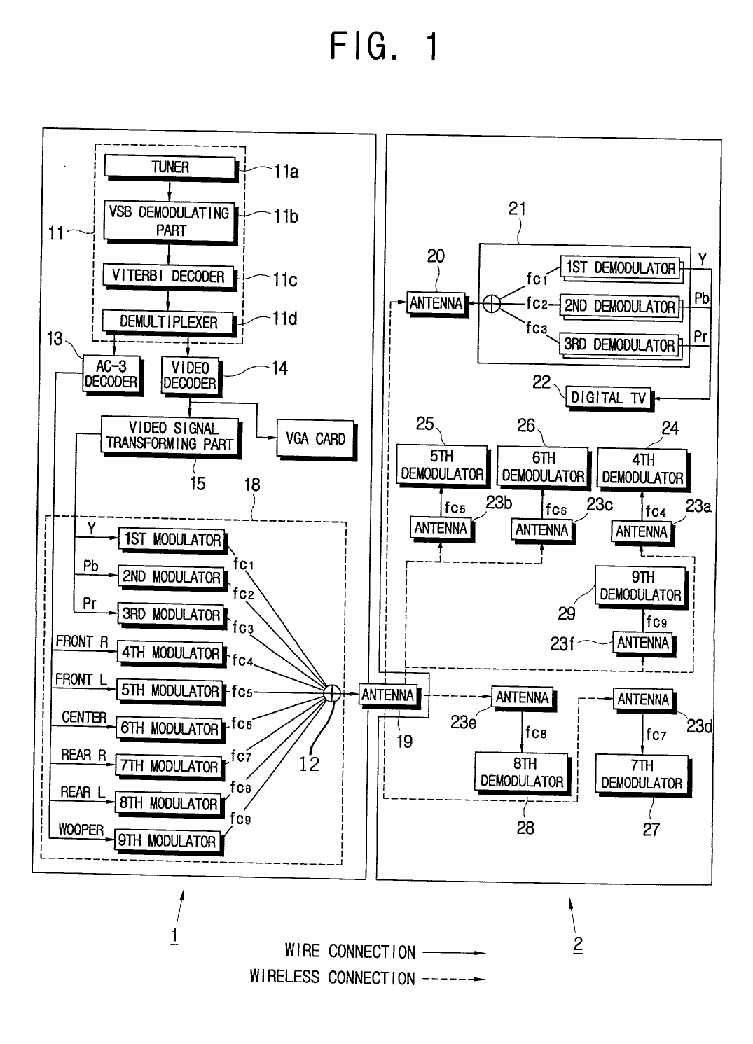

FIG. 1 is a block diagram of a system according to the present invention for restoring a digital TV signal. As shown therein, the system according to the present invention for reproducing the digital TV signal is comprised of a computer system 1 and a display system 2.

The computer system 1 comprises a digital TV tuner card 11, a wireless module (wireless transmitter) 18 having a plurality of modulators dividing video and audio signals outputted from the digital TV tuner card 11 to a plurality of channels, and modulating them into high frequency signals, and an antenna 19 wirelessly transmitting signals modulated by the modulators.

The display system 2 comprises a plurality of wireless receivers comprising a plurality of antennas receiving the modulated signals transmitted from the computer system 1, a plurality of demodulators demodulating the high frequency signals received through the plurality of antennas, a display apparatus 22 displaying the video signals demodulated by the demodulators, and an audio apparatus outputting the audio signals demodulated by the demodulators.

The digital TV tuner card 11 includes a tuner 11a receiving the TV signal, a VSB (Vestigial Side Band) demodulating part 11b demodulating a high frequency signal received by the tuner 11a into a VSB analog signal, a viterbi decoder 11c transforming the VSB analog signal into a digital signal, and a demultiplexer lid dividing the digital signal transformed by the viterbi decoder 11c into the video signal and the audio signal.

The computer system 1 further comprises a video decoder 14 decoding the video signal, which was compressed by an MPEG-2 manner and received from the digital TV tuner card 11, an AC-3 audio decoder 13 dividing the audio signal into six audio signals corresponding to 5.1 channels and decoding them in an AC-3 manner, a video signal transforming part 15 transforming R/G/B signals decoded by the video decoder 14 into Y/Pb/Pr signals, the wireless module 18 having 1^{st}˜3^{rd} video modulators and 4^{th}˜9^{th} audio modulators, a signal combiner 12 for combining the signals modulated at the 1^{st}˜9^{th} modulators and the antenna 19 wirelessly transmitting the combined signals. Herein, the 1^{st}˜3^{rd} modulators respectively modulate the Y/Pb/Pr signals transformed by the video signal transforming part 15 into high frequency signals having an intermediate frequency such as fc1/fc2/fc3, and the 4^{th}˜9^{th}modulators respectively modulate the six audio signals decoded into high frequency signals having an intermediate frequency such as fc4/fc5/fc6/fc7/fc8/fc9 by the audio decoder 13 in the AC-3 manner.

On the other hand, in the display system 2, the antenna 20 receives the Y/Pb/Pr signals transmitted from the computer system 1, and the 1^{st}˜3^{rd} demodulators 21 respectively demodulate the high frequency Y/Pb/Pr signals into low frequency signals via the corresponding channels, thereby transmitting the Y/Pb/Pr signals demodulated by the 1^{st}˜3^{rd} demodulators to the display apparatus 22. Herein the display apparatus 22 is comprised of the digital TV 22 processing the Y/Pb/Pr signals and displaying them thereon.

The audio apparatus is comprised of a six speakers (not shown) applicable to the 5.1 channels and arranged (indoors) at specific positions in which a stereophonic sound can be reproduced. That is, three (front R, front L, center) speakers are arranged in front of a TV viewer, two (rear R, rear L) speakers are arranged in rear of the TV viewer, and one speaker (woofer) outputs a bass sound.

Each speaker of the audio apparatus is comprised of a speaker applicable to the 5.1 channels, and connected to the antennas 23a˜23f receiving the audio signal transmitted from the antenna 19 of the computer system 1 according to the 5.1 channels, and 4^{th}9^{th} demodulators 24˜29 respectively demodulating the high frequency signals received at the antennas 23a˜23f according to the 5.1 channels.

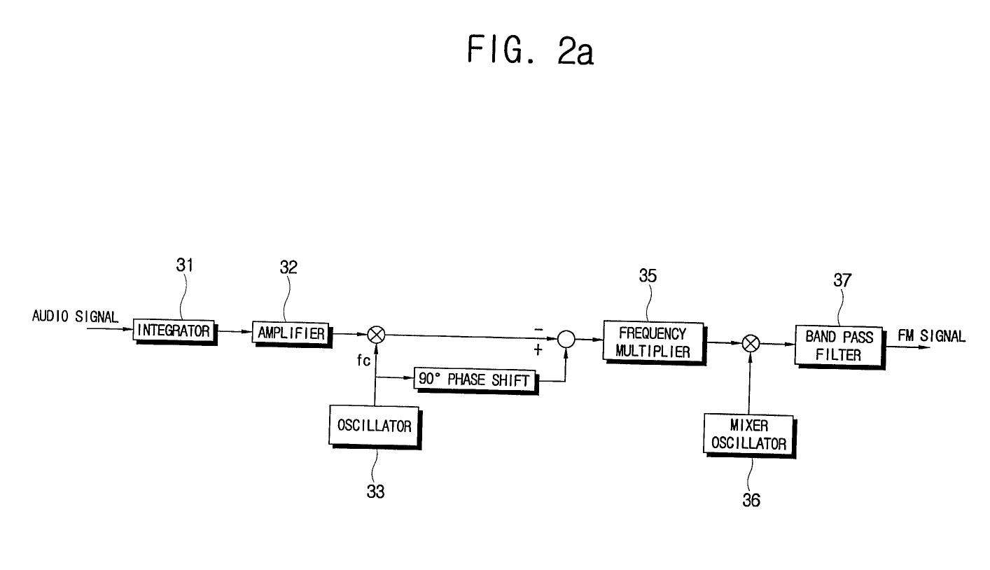

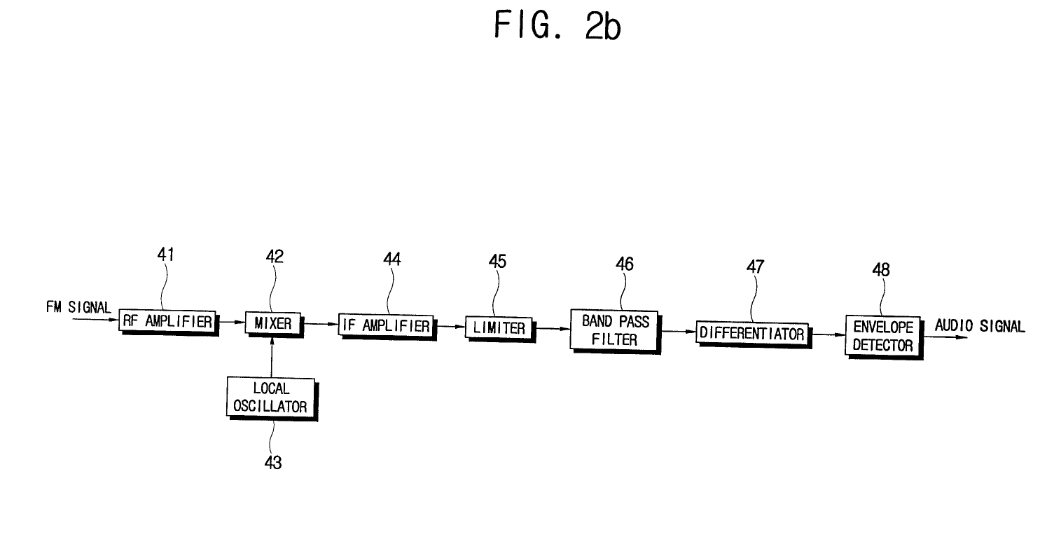

Regarding each of the 4^{th}9^{th} audio modulators, as shown in FIG. 2a the analog audio signal passes through an integrator 31 and an amplifier 32 amplifying the signals, and is then multiplied by sinusoidal wave signal generated from an oscillator 33. Thereafter, the audio signal multiplied by the sinusoidal wave signal is transformed into a negative signal and synthesized with a 90° phase transformed signal generated from the oscillator 33, and is then transformed into a signal within limits of an appropriate frequency band by passing through a frequency multiplier 35. Thereafter, the transformed signal is mixed with a sinusoidal signal generated from a mixer oscillator 36, and then passes through a BPF (band pass filter) 37, to thereby output an FM (Frequency Modulation) signal modulated into a high frequency signal having an intermediate frequency.

Regarding each of the 4^{th}˜9^{th} audio demodulators, as shown in FIG. 2b the demodulation process of the audio signal will be explained. The high frequency FM audio signal is inputted to an RF (Radio frequency) amplifier 41 so as to be amplified. The amplified signal is mixed with a sinusoidal wave signal, generated from a local oscillator 43, by a mixer 42 so as to transform the intermediate frequency, and then inputted to a BPF 46 by passing through an IF (intermediate frequency) amplifier 44 and a hard limiter 45. The signal inputted to the BPF 46 becomes a signal in a specific frequency band by filtering, and then differentiated by a differentiator 47. Thereafter, an envelope of the differentiated signal is detected by an envelope detector 48 so as to be restored to a low frequency analog audio signal.

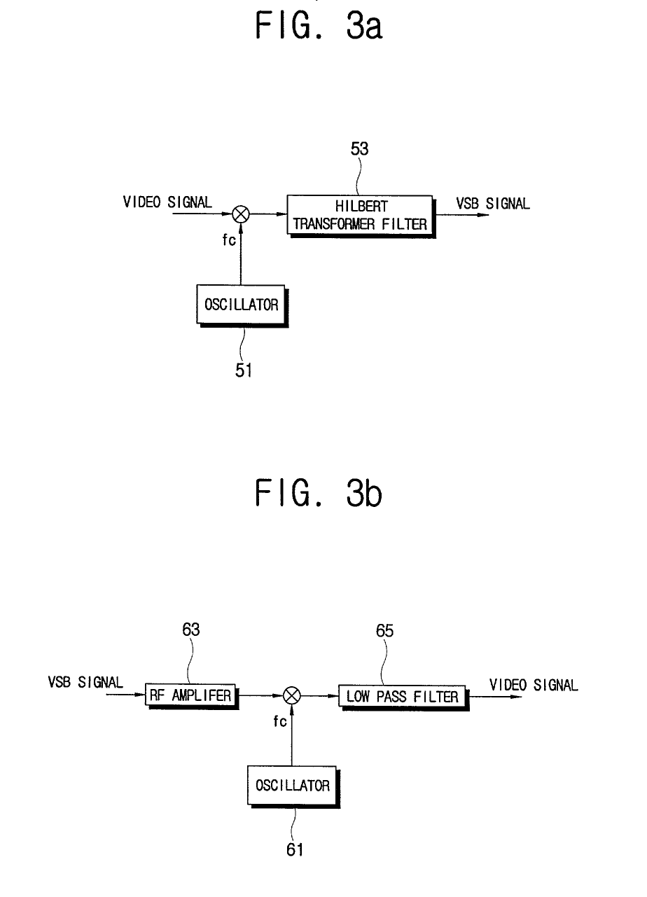

Regarding each of the 1^{st}˜3^{rd} audio modulators, as shown in FIG. 3a the video signal is multiplied by a sinusoidal wave signal generated from an oscillator 51 and then passes through a Hilbert transformer filter 53 so as to be modulated to a high frequency FM VSB signal. Further, regarding each of the 1^{st}3^{rd} audio demodulators, as shown in FIG. 3b the high frequency FM VSB video signal is amplified through an RF amplifier 63 and then passes through a low pass filter 65 after being multiplied by a sinusoidal wave signal generated from an oscillator 61 so as to be restored to a low frequency analog video signal.

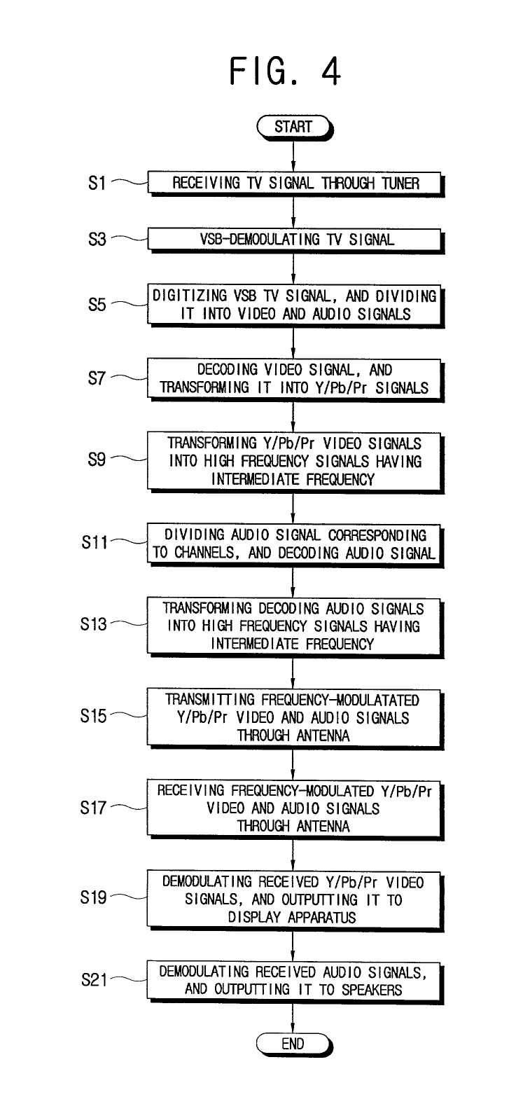

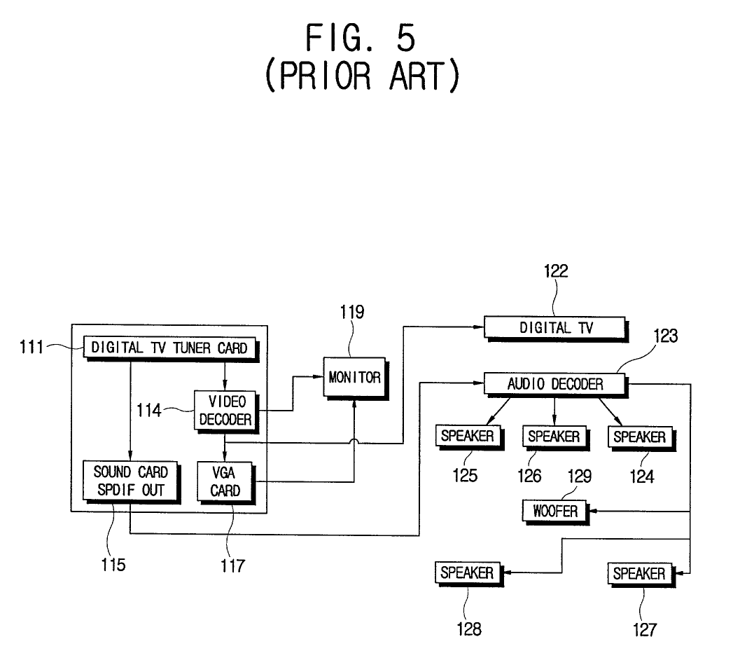

As shown in FIG. 4, the steps of S1˜S15 shows a process in the computer system 1, and the steps of S17˜S21 shows a process in the display system 2. As shown therein, when the tuner 11a receives a TV signal (S1), the VSB demodulating part 11b demodulates the TV signal into the VSB analog signal (S3). Thereafter, the viterbi decoder 11c transforms the demodulated TV signal into a digital signal, and then the demultiplexer 11d divides it into a video signal and an audio signal (S5). Thereafter, the video decoder 14 decodes the video signal in the MPEG-2 manner so as to get Y/Cb/Cr signals and transforms the Y/Cb/Cr signals into R/G/B signals, and then the video signal transforming part 15 transforms the R/G/B signals into Y/Pb/Pr signals (S7). The Y/Pb/Pr signals are transmitted to the 1^{st}˜^{rd} modulators. Simultaneously with the process of the video signal, the audio signal is decoded into six audio signals corresponding to the 5.1 channels (S11). The decoded audio signals are transmitted to the 4^{th˜}9^{th} modulators. The Y/Pb/Pr signals inputted to the 1^{st}18 3^{rd} modulators are respectively frequency-modulated into high frequency video signals having an intermediate frequency different each other (S9), and the 5.1 channel audio signals inputted to the 4^{th}˜9^{th} modulators are modulated into high frequency audio signals having an intermediate frequency different from each other (S13). The high frequency video and audio signals are wirelessly transmitted to the display system 2 through the antenna 19 (S15).

The high frequency video signals transmitted from antenna 19 are received through the antenna 20 of the digital TV 22 of the display system 2 (S17). The received video signals are respectively restored to the Y/Pb/Pr signals through the 1^{st}˜3^{rd} demodulators and transmitted to the digital TV 22 (S19). The high frequency audio signals are respectively received through the antennas 23a˜23f provided at the speakers according to the 5.1 channels, and transmitted to the speakers after being restored to low frequency analog audio signals through the modulators 24˜29 connected to the speakers (S21).

With this configuration, where a digital TV signal received at a digital TV tuner card of a computer system is displayed through a remote display apparatus, the digital TV signal which is comprised of video signals and audio signals according to channels frequency-modulated through a wireless module provided at the computer system is transmitted by wireless, and the transmitted digital TV signals are received by a display system through antennas corresponding to the signals, thereby displaying the digital TV signal without separate cables.

As described above, the present invention provides a system and a method for restoring a digital TV signal, in which the digital TV signal is wirelessly transmitted from a computer system and is restored at a remote display apparatus.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A system for reproducing a digital TV signal, comprising a computer system and a display system, the computer system comprising:
a signal dividing means receiving the digital TV signal, and dividing the digital TV signal into digital video signals and digital audio signals after a predetermined signal processing,
a video decoding means decoding the digital video signals outputted from the signal dividing means into analog video signals, and outputting low frequency analog video signals by colors,
an audio decoding means decoding the digital audio signals outputted from the signal dividing means into analog audio signals with a plurality of channels corresponding to predetermined frequencies,
a plurality of frequency-modulators frequency-modulating the low frequency analog video signals and the analog audio signals, in response to intermediate frequencies, respectively, and
a wireless transmitter wirelessly transmitting the signals modulated by the frequency-modulators; and
the display system having:
a plurality of first wireless receivers wirelessly receiving the analog audio signals transmitted from the wireless transmitter, via the channels,
a plurality of first frequency demodulators respectively connected to the first wireless receivers and frequency-demodulating the analog audio signals,
a plurality of second wireless receivers wirelessly receiving the analog video signals transmitted from the wireless transmitter,
a plurality of second frequency demodulators respectively connected to the second wireless receivers and frequency-demodulating the analog video signals by the colors, and
display and audio apparatuses outputting the video and audio signals demodulated by the first and second frequency demodulators, respectively.

2. The system according to claim 1, wherein the signal dividing means is comprised of a digital TV tuner card including a tuner receiving the digital TV signal, a VSB (Vestigial Side Band) demodulating part demodulating a high frequency signal received by the tuner into a VSB analog signal, a Viterbi decoder transforming the VSB analog signal into a digital signal, and a demultiplexer dividing the digital signal transformed by the Viterbi decoder into the video signal and the audio signal.

3. The system according to claim 2, wherein the video decoding means includes a video decoder decoding the video signal outputted from the digital TV tuner card into RIG/B signals, and a video signal transforming part transforming the RIG/B signals into Y/Pb/Pr low frequency analog video signals.

4. The system according to claim 2, wherein the audio decoding means includes an audio decoder decoding the audio signal outputted from the digital TV tuner card into six audio signals corresponding to 5.1 channels in an AC-3 manner.

5. The system according to claim 4, wherein the audio apparatus is comprised of six speakers applicable to the 5.1 channels.

6. The system according to claim 1, wherein the wireless transmitter and the first and second wireless receivers are comprised of at least one antenna, respectively.

7. A system for restoring a digital video signal, comprising a computer system and a display system, the computer system comprising:
a video signal outputting means outputting the digital video signal,
a video decoding means decoding the digital video signals outputted from the video signal outputting means into analog video signals, and outputting low frequency analog video signals by colors,
a plurality of frequency-modulators frequency-modulating the low frequency analog video signals into high frequency signals, in response to intermediate frequencies, respectively, and
a wireless transmitter wirelessly transmitting the signals modulated by the frequency-modulators; and
the display system comprising:
a plurality of wireless receivers wirelessly receiving the analog video signals transmitted from the wireless transmitter,
a plurality of frequency demodulators respectively connected to the wireless receivers and frequency-demodulating the analog video signals by colors, and
a display apparatus outputting the video signals demodulated by the frequency demodulators.

8. The system according to claim 7, wherein the video signal outputting means is comprised of a digital TV tuner card including a tuner receiving the digital TV signal, a VSB (Vestigial Side Band) demodulating part demodulating a high frequency signal received by the tuner into a VSB analog signal, a viterbi decoder transforming the VSB analog signal into a digital signal, and a demultiplexer dividing the digital signal transformed by the viterbi decoder into the video signal and the audio signal.

9. The system according to claim 8, wherein the video decoding means includes a video decoder decoding the video signal outputted from the digital TV tuner card into R/G/B signals, and a video signal transforming part transforming the R/G/B signals into Y/Pb/Pr low frequency analog video signals.

10. A system for restoring a digital audio signal, comprising a computer system and an audio system, the computer system comprising:
an audio signal outputting means outputting the digital audio signal,
an audio decoding means decoding the digital audio signals outputted from the audio signal outputting means into analog audio signals after dividing the digital audio signals corresponding to a plurality of channels having predetermined frequencies,
a plurality of frequency-modulators frequency-modulating the low frequency analog audio signals into high frequency signals, in response to intermediate frequencies, respectively, and
a wireless transmitter wirelessly transmitting the signals modulated by the frequency-modulators; and
the audio system comprising:
a plurality of wireless receivers wirelessly receiving the analog audio signals transmitted from the wireless transmitter,
a plurality of frequency demodulators respectively connected to the wireless receivers and frequency-demodulating the analog audio signals corresponding to the channels, and
an audio apparatus outputting the audio signals demodulated by the frequency demodulators.

11. The system according to claim 10, wherein the audio signal outputting means is comprised of a digital TV tuner card including a tuner receiving the digital TV signal, a VSB (Vestigial Side Band) demodulating part demodulating a high frequency signal received by the tuner into a VSB analog signal, a viterbi decoder transforming the VSB analog signal into a digital signal, and a demultiplexer dividing the digital signal transformed by the viterbi decoder into the video signal and the audio signal.

12. The system according to claim 11, wherein the audio decoding means includes an audio decoder decoding the audio signal outputted from the digital TV tuner card into six audio signals corresponding to 5.1 channels in an AC-3 manner.

13. The system according to claim 12, wherein the audio apparatus is comprised of six speakers applicable to the 5.1 channels.

14. A method for restoring a digital TV signal, comprising the steps of:
dividing the digital TV signal into a digital video signal and an digital audio signal after a predetermined signal processing;
decoding the digital video signal into low frequency analog video signal, by colors;
decoding the digital audio signal into analog audio signal with a plurality of channels corresponding to predetermined frequencies;
modulating the low frequency analog video and audio signals into high frequency signals having predetermined intermediate frequencies, respectively;
transmitting at least one of the frequency-modulated video and audio signals by wireless;
receiving at least one of the transmitted video and audio signals and demodulating the received signals; and
outputting at least one of the demodulated video and audio signals to display and audio apparatuses.

15. The method according to claim 14, wherein the step of decoding the digital audio signal comprises the step of transforming the digital audio signal into six signals corresponding to 5.1 channels.

16. The method according to claim 14, wherein the audio apparatus is comprised of six speakers applicable to 5.1 channels.

17. A system for reproducing a digital TV signal, comprising:
a computer system comprising:
a digital TV tuner card for receiving the digital TV signal and separating an audio signal and a video signal in MPEG-2 format from the digital TV signal for output;
an AC-3 audio decoder for receiving the separated audio signal and outputting 5.1 channel audio;
a video decoder for receiving the separated MPEG-2 video signal and outputting an R/G/B video signal;
a video signal converter for receiving the R/G/B video signal and outputting a Y/Pb/Pr video signal;
a wireless module separately modulating each video component and each audio component of said Y/Pb/Pr video signal and said 5.1 channel audio using different center frequencies, combining the modulated signals and wirelessly transmitting the combined signal from a first antenna; and
a display system comprising:
first through sixth antennas and corresponding first through sixth demodulators for receiving the combined signal and outputting recovered 5.1 channel audio to a speaker system; and
a seventh antenna and seventh through ninth demodulators for receiving the combined signal and outputting recovered Y/Pb/Pr video signals to a digital TV for display.
